(19) United States
(12) Patent Application Publication
(10) Pub. No.: US 2023/0070715 A1
(43) Pub. Date: Mar. 9, 2023

(54) TEXT PROCESSING METHOD AND APPARATUS

(71) Applicant: CANON MEDICAL SYSTEMS CORPORATION, Otawara-shi (JP)

(72) Inventors: Maciej PAJAK, Edinburgh (GB); Alison O'NEIL, Edinburgh (GB); Hannah WATSON, Edinburgh (GB)

(73) Assignee: CANON MEDICAL SYSTEMS CORPORATION, Otawara-shi (JP)

(21) Appl. No.: 17/447,229

(22) Filed: Sep. 9, 2021

(51) Int. Cl. G06F 40/284; G06F 40/30; G06N 5/02

(52) U.S. Cl. CPC G06F 40/284; G06F 40/30; G06N 5/02

(57) ABSTRACT

A medical information processing apparatus comprises: a memory which stores a plurality of semantic ranking values for a plurality of medical terms, wherein each of the semantic ranking values relates to a degree of semantic similarity between a respective pair of the medical terms; and processing circuitry configured to train a model based on the semantic ranking values, wherein the model comprises a respective vector representation for each of the medical terms.

### FIELD

Embodiments described herein relate generally to a method and apparatus for text processing, for example for obtaining a vector representation of a set of medical terms.

### BACKGROUND

It is known to perform natural language processing (NLP), in which free text or unstructured text is processed to obtain desired information. For example, in a medical context, the text to be analyzed may be a clinician's text note. The text may be analyzed to obtain information about, for example, a medical condition or a type of treatment. Natural language processing may be performed using deep learning methods, for example using a neural network.

In order to perform natural language processing, text may first be pre-processed to obtain a representation of the text, for example a vector representation. A state-of-the-art representation of text in deep learning natural language processing is based on embeddings.

In a representation that is based on embeddings, the text is considered as a set of word tokens. A word token may be, for example, a single word, a group of words, or a part of a word. A respective embedding vector is assigned to each word token.

Embedding vectors are dense vectors assigned to word tokens. An embedding vector may comprise, for example, between 100 and 1000 elements.

In some cases, embeddings at word-piece level or at character level may be used. In some cases, embeddings may be context-dependent.

Embedding vectors capture semantic similarity between word tokens in a multi-dimensional embedding space. An embedding may be a dense (vector) representation of a semantic space of words.

In one example, the word ‘acetaminophen’ is close to ‘apap’ and ‘paracetamol’ in the multi-dimensional embedding space, because ‘acetaminophen’, ‘apap’ and ‘paracetamol’ all describe the same medication.

Embeddings may be used as part of a larger neural architecture. For example, embedding vectors may be used as input to a deep learning model, for example a neural network.

Embeddings may be used directly in information retrieval. For example, a similarity between embedding vectors may be used to find alternative words related to a user query, to index documents accurately, or to evaluate relatedness between a query and an entire candidate sentence in a clinical document.

FIG. 1 shows an example of using an embedding space 2 directly in an information retrieval system. A two-dimensional representation of the embedding space 2 is shown in FIG. 1. In practice, the embedding space 2 is multi-dimensional, with a number of dimensions that correspond to a length of the embedding vectors.

A first dot 10 in the embedding space 2 represents an embedding vector that corresponds to an input query. The input query is a term that a user types into a search box. For example, the term may be a word.

Other dots 12 in FIG. 1 correspond to other terms, for example other words. A query expansion may be performed by identifying terms that are nearest neighbors to the input query in the embedding space. In FIG. 1, the nearest neighbor terms are those represented by the dots 12A, 12B, 12C, 12D, 12E, 12F that are nearest to the first dot 10 representing the input query. Lines are drawn in FIG. 1 to represent the nearest-neighbor relationship of the terms represented by the dots 12A, 12B, 12C, 12D, 12E, 12F to the input query represented by first dot 10.

There are multiple known ways of learning an embedding space for words, for example Word2vec (see, for example, U.S. Pat. No. 9,037,464B1 and Mikolov, T., Chen, K., Corrado, G., & Dean, J. (2013). Efficient estimation of word representations in vector space. arXiv preprint arXiv:1301.3781), GloVe (see, for example, Pennington, J., Socher, R., & Manning, C. (2014, October). Glove: Global vectors for word representation. In Proceedings of the 2014 conference on empirical methods in natural language processing (EMNLP) (pp. 1532-1543) and fastText (see, for example, Joulin, A., Grave, E., Bojanowski, P., & Mikolov, T. (2016). Bag of tricks for efficient text classification. arXiv preprint arXiv:1607.01759).

Transformer models produce contextual embeddings in which a word's representation depends on the host sentence. An example of a transformer model is BERT (Devlin, J., Chang, M. W., Lee, K. and Toutanova, K., 2018. Bert: Pre-training of deep bidirectional transformers for language understanding. https://arxiv.org/abs/1810.04805

Word embeddings (for example, word2vec and BERT) are traditionally trained, or pre-trained, from contextual information. This training is considered to be self-supervised or unsupervised learning which may require only a large corpus of text. No labels may be required.

FIG. 2 represents a method of training an embedding from contextual information. A large clinical text corpus 20 is obtained. The clinical text corpus 20 is used to train an embedding 22 using a standard pre-training task 24, for example word2vec. The standard pre-training task 24 comprises training the embedding using a large corpus of text. Arrow 25 represents the performing of the standard pre-training task 24 to train the embedding 22. Multiple iterations of the standard pre-training task 24 may be performed, with the embedding updated at each iteration.

An output of the training process is a trained embedding 22 which comprises a respective vector representation of each of a plurality of words from the training corpus.

Vector representations for some of the plurality of words are illustrated in FIG. 2 as dots in a word embedding space 26 which is visualized in 2 dimensions. A proximity of dots in the word embedding space 26 is representative of a degree of similarity as determined by the trained embedding 22.

A solid black dot represents a starting query term. Triangular elements represent terms that have strong relevance to the starting query term, for example terms that are clinical synonyms. Unfilled circular elements represent terms that have weak relevance to the starting query term, for example terms that are clinically associated with the starting query term but are not synonyms of the starting query term. For example, metformin and insulin may be considered to be weakly related terms because both metformin and insulin directly treat diabetes, albeit via different pharmacological actions and for different degrees of diabetic severity or progression.

Diamond-shaped elements represent terms that are contextual confounders of the starting query term. Contextual confounders are concepts that appear in a similar context to the starting query term within the clinical text corpus 20, but are not synonyms. For example, metformin and atorvastatin may be considered to be contextual confounders. Metformin is a medication that treats diabetes. Atorvastatin is a medication that treats high cholesterol. Atorvastatin is commonly prescribed to patients with diabetes because patients with diabetes are more at risk of heart disease and therefore maintaining low cholesterol is important. Many non-diabetics also take atorvastatin for cholesterol. Metformin and atorvastatin might appear in a similar context because they are both medications which are commonly prescribed to patients with diabetes. However, metformin and atorvastatin are not synonyms and the clinical relationship between metformin and atorvastatin may be considered not to be particularly noteworthy when interpreting a sentence.

Square elements represent terms that are irrelevant to the starting query term.

In the example of FIG. 2, training the embedding 22 on the text corpus alone may not allow the embedding 22 to distinguish fully between strongly relevant terms, weakly relevant terms and contextual confounders. The closest neighbors to the starting query term in the embedding space 26 include strongly relevant terms, weakly relevant terms and contextual confounders.

It has been found that an embedding that is trained from contextual information may not reflect semantic relationships. When the embedding is leveraged for finding similar words, it has been found that synonyms may not be perfectly grouped. In general, context is not a sufficient condition for similarity.

Examples of relationships that have successfully emerged in embedding spaces include gender (man-woman and king-queen), tense (walking-walked and swimming-swam) and country-capital (Turkey-Ankara, Canada-Ottawa, Spain-Madrid, Italy-Rome, Germany-Berlin, Russia-Moscow, Vietnam-Hanoi, Japan-Tokyo, China-Beijing). However, it has been found that emergence of useful relationships may not be reliable.

In some circumstances, an embedding trained on a clinical text corpus may reflect linguistic relationships between words but may not correctly reflect clinical relationships between the words. For example, words that occur in a similar context may not have the same clinical meaning.

The nearest neighbor terms to a starting query may include some or all of: terms having strong relevance to the starting query, terms having weak relevance to the starting query, contextual confounders, and irrelevant terms.

### SUMMARY

In a first aspect, there is provided a medical information processing apparatus comprising: a memory which stores a plurality of semantic ranking values for a plurality of medical terms, wherein each of the semantic ranking values relates to a degree of semantic similarity between a respective pair of the medical terms; and processing circuitry configured to train a model based on the semantic ranking values, wherein the model comprises a respective vector representation for each of the medical terms.

The training of the model may comprise at least one training task in which the model is trained on the semantic ranking values. The training of the model may comprise a further, different training task in which the model is trained using word context in a text corpus.

The training of the model may comprise performing at least part of the further, different training task concurrently with at least part of the at least one training task.

At least some of the semantic ranking values may be determined based on a knowledge base. The knowledge base may comprise a knowledge graph that represents relationships between the plurality of medical terms as edges in the knowledge graph.

The processing circuitry may be further configured to perform the determining of the semantic ranking values based on the knowledge graph. The determining may comprise, for each pair of medical terms, applying at least one rule based on types of edge and number of edges between the pair of medical terms to obtain the semantic ranking value for said pair of medical terms.

At least some of the semantic ranking values may be obtained by expert annotation of pairs of the medical terms according to an annotation protocol.

The processing circuitry may be further configured to receive user input and to process the user input to obtain at least some of the semantic ranking values.

The semantic ranking value for each pair of medical terms may comprise numerical information that is indicative of the degree of semantic similarity between the pair of medical terms.

The training of the model may comprise using a loss function that is based on the semantic ranking values.

The at least one training task may comprise ranking words according to a degree of relatedness to a reference word.

The at least one training task comprise predicting a class of a relationship between two words.

The at least one training task may comprise maximizing or minimizing a cosine similarity between vector representations.

The vector representation for each of the medical terms may be dependent on the context of said medical term within a text.

The processing circuitry may be further configured to use the vector representations to perform an information retrieval task.

The information retrieval task may comprise finding an alternative word for a user query. The information retrieval task may comprise indexing a document. The information retrieval task may comprise evaluating a relationship between a user query and one or more words within a document.

The processing circuitry may be further configured to receive input text data. The processing circuitry may be further configured to pre-process the input text data using the model to obtain a vector representation of the input text data. The processing circuitry may be further configured to use a further model to process the vector representation of the input text data to obtain a desired output.

The desired output may comprise a labeling of the input text data. The desired output may comprise extraction of information from the input text data. The desired output may comprise a classification of the input text data. The desired output may comprise a summarization of the input text data.

In a further aspect, which may be provided independently, there is provide a method comprising: obtaining a plurality of semantic ranking values for a plurality of medical terms, wherein each of the semantic ranking values relates to a degree of semantic similarity between a respective pair of the medical terms; and training a model based on the semantic ranking values, wherein the model comprises a respective vector representation for each of the medical terms.

In a further aspect, which may be provided independently, there is provided a medical information processing apparatus comprising processing circuitry configured to: apply a model to input text data to obtain a vector representation of the input text data, wherein the model is trained based on a plurality of semantic ranking values for a plurality of medical terms, each of the semantic ranking values relating to a degree of semantic similarity between a respective pair of the medical terms; and use the vector representation of the input text data to perform an information retrieval task, or use a further model to process the vector representation of the input text data to obtain a desired output.

In a further aspect, which may be provided independently, there is provided a method comprising: applying a model to input text data to obtain a vector representation of the input text data, wherein the model is trained based on a plurality of semantic ranking values for a plurality of medical terms, each of the semantic ranking values relating to a degree of semantic similarity between a respective pair of the medical terms; and using the vector representation of the input text data to perform an information retrieval task, or using a further model to process the vector representation of the input text data to obtain a desired output.

In a further aspect, which may be provided independently, there is provided a natural language processing method for information retrieval tasks, learning from training data examples, to generate a representation of tokens as multidimensional vectors. The representation space is trained on multiple tasks. One task is prediction of a word from context—continuous bag of words and negative log likelihood loss, or any other task which only uses word context in a large corpus. One task is ranking words according to the degree of relatedness to a reference word using a margin ranking loss and cosine similarities loss. One task is prediction of a class of the relationship between 2 words. Supervision/annotations are according to clinical rules.

Tokens may be word pieces. Embeddings may be context-dependent. Data annotations may come from clinically defined rules applied to a knowledge graph. Data annotations may come from annotation of pairs of words according to a clinically defined annotation protocol. Data annotations may come from user interactions with the system.

In a further aspect, which may be provided independently, there is provided a medical information processing apparatus comprising: a memory which stores a plurality of parameters relating to similarities of semantic relationship between the plurality of medical terms, processing circuitry configured to train a word embedding based on the parameters.

The parameters may be determined based on knowledge-graph relating to the plurality of medical terms.

The parameters may be numerical information corresponding to the similarities of semantic relationship between the plurality of medical terms.

The processing may be further configured to train the word embedding by using a loss function which is based on the parameters.

In a further aspect, which may be provided independently, there is provided a natural language processing method for information retrieval tasks, comprising performing a training process using training data examples to generate a representation of tokens as multidimensional vectors in a representation space, the method comprising performing the training process with respect to a plurality of different tasks.

At least one of the tasks may comprise using word context in a large corpus of words, optionally based on negative log likelihood loss.

At least one of the tasks may comprise ranking words according to the degree of relatedness to a reference word, optionally using a margin ranking loss and cosine similarities loss.

At least one of the tasks may comprise prediction of a class of a relationship between two words.

At least one of the tasks may comprise obtaining, or may be based on, annotations according to clinical rules.

The tokens may be word pieces.

The vectors may comprise context-dependent embeddings.

The annotations may be obtained from clinically defined rules applied to a knowledge graph.

The annotations may comprise annotations of pairs of words according to a clinically defined annotation protocol.

The annotations may be obtained from user interactions.

Features in one aspect may be provided as features in any other aspect as appropriate.

For example, features of a method may be provided as features of an apparatus and vice versa. Any feature or features in one aspect may be provided in combination with any suitable feature or features in any other aspect.

### BRIEF DESCRIPTION OF THE DRAWINGS

Embodiments are now described, by way of non-limiting example, and are illustrated in the following figures, in which:

FIG. 1 is a diagram that is representative of an embedding space;

FIG. 2 is a flow chart illustrating in overview a method for training an embedding;

FIG. 3 is a schematic illustration of an apparatus in accordance with an embodiment;

FIG. 4 is a flow chart illustrating in overview a method for training an embedding in accordance with an embodiment;

FIG. 5 is a schematic illustration showing ranking of nodes in a knowledge graph; and

FIG. 6 is a flow chart illustrating in overview a method for training an embedding in accordance with an embodiment, including examples of losses.

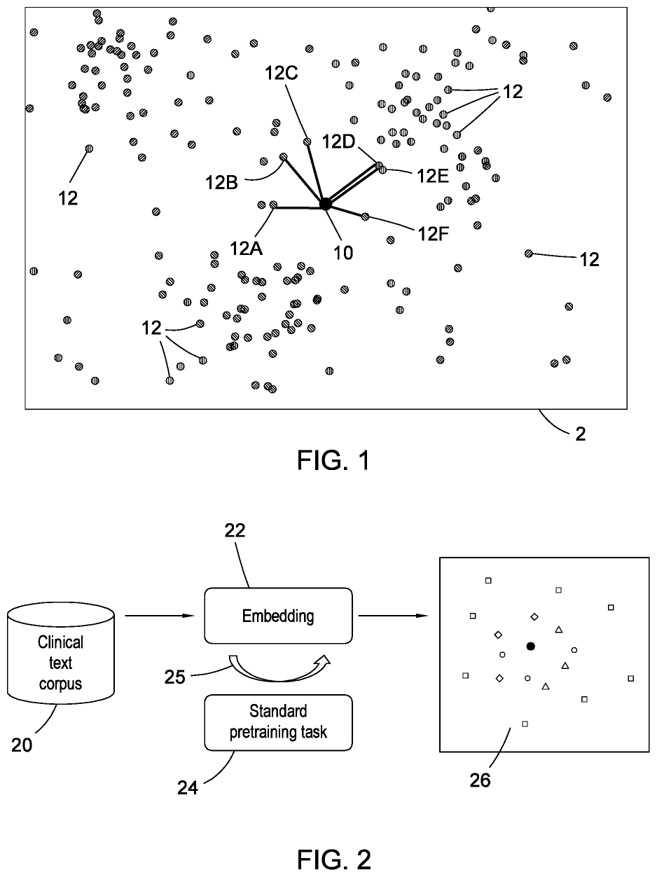

### DETAILED DESCRIPTION

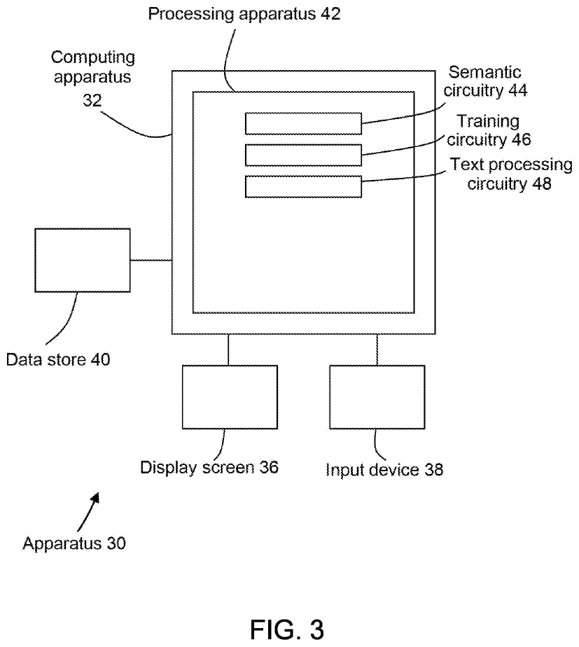

An apparatus 30 according to an embodiment is illustrated schematically in FIG. 3. The apparatus 30 may be referred to as a medical information processing apparatus.

In the present embodiment, the apparatus 30 is configured to train a model to provide a vector representation for text and to use the trained model to perform at least one text processing task, for example an information retrieval, information extraction, or classification task. In other embodiments, a first apparatus may be used to train the model and a second, different apparatus may use the trained model to perform the at least one text processing task.

The apparatus 30 comprises a computing apparatus 32, which in this case is a personal computer (PC) or workstation. The computing apparatus 32 is connected to a display screen 36 or other display device, and an input device or devices 38, such as a computer keyboard and mouse.

The computing apparatus 32 receives semantic information and medical text from a data store 40. In alternative embodiments, computing apparatus 32 may receive the semantic information and/or medical text from one or more further data stores (not shown) instead of or in addition to data store 40. For example, the computing apparatus 32 may receive semantic information and/or medical text from one or more remote data stores (not shown) which may form part of a Picture Archiving and Communication System (PACS) or other information system.

Computing apparatus 32 provides a processing resource for automatically or semi-automatically processing medical text data. Computing apparatus 32 comprises a processing apparatus 42. The processing apparatus 42 comprises semantic circuitry 44 configured to receive and/or generate semantic information; training circuitry 46 configured to train a model using the semantic information; and text processing circuitry 48 configured to use the trained model to perform a text processing task.

In the present embodiment, the circuitries 44, 46, 48 are each implemented in computing apparatus 32 by means of a computer program having computer-readable instructions that are executable to perform the method of the embodiment. However, in other embodiments, the various circuitries may be implemented as one or more ASICs (application specific integrated circuits) or FPGAs (field programmable gate arrays).

The computing apparatus 32 also includes a hard drive and other components of a PC including RAM, ROM, a data bus, an operating system including various device drivers, and hardware devices including a graphics card. Such components are not shown in FIG. 3 for clarity.

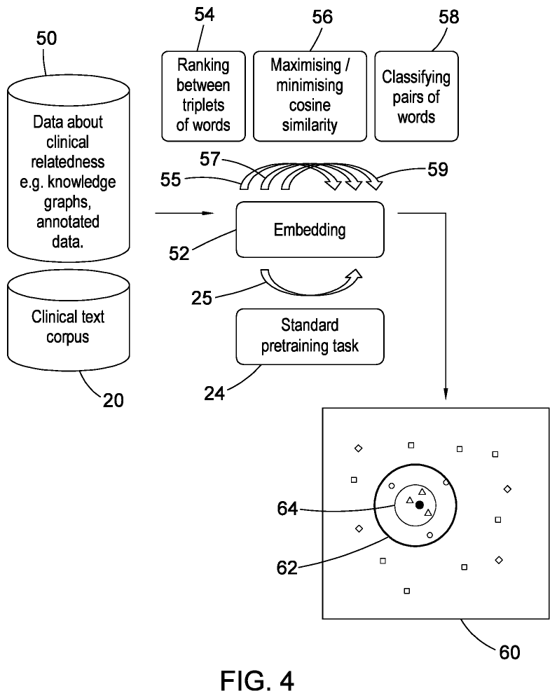

The apparatus of FIG. 3 is configured to perform a method of an embodiment as shown in FIG. 4.

The training circuitry 46 receives data about clinical relatedness 50 from data store 40. In other embodiments, the data about clinical relatedness 50 may be obtained from any suitable data store. The data about clinical relatedness 50 may comprise, or be derived from, one or more knowledge bases, for example one or more knowledge graphs. The data about clinical relatedness 50 may comprise, or be derived from, a set of annotated data, for example data that has been annotated by an expert.

In the embodiment of FIG. 4, the data about clinical relatedness 50 comprises a plurality of semantic ranking values. Each of the semantic ranking values is representative of a relationship between a respective pair of medical terms. In the embodiment of FIG. 4, each of the semantic ranking values comprises at least one numerical value that is representative of the relationship between a first medical term of a pair of medical terms, and a second medical term of the pair of medical terms.

Medical terms may be, for example, text terms that relate to anatomy, pathology or pharmaceuticals. Medical terms may be terms that are included in a medical knowledge base or ontology. Each of the medical terms may comprise a word, a word-piece, a phrase, an acronym, or any other suitable text term.

The training circuitry 46 also receives a clinical text corpus 20 from data store 40. In other embodiments, the clinical text corpus 20 may be received from any suitable data store. The text included in the clinical text corpus 20 includes medical terms and other text terms. The clinical text corpus 20 may comprise unlabeled medical text data. The clinical text corpus may comprise, for example, text data from a plurality of radiology reports.

In the embodiment of FIG. 4, the training circuitry 46 trains an embedding 52 using four training tasks 24, 54, 56, 58. In other embodiments, any suitable number of training tasks may be used. Any suitable type of model may be trained.

Task 24 is a standard pre-training task which is performed using the clinical text corpus 20. Arrow 25 represents the performing of the standard pre-training task 24 to train the embedding 52. The standard pre-training task may comprise self-supervised or unsupervised training. In the embodiment of FIG. 4, the standard pre-training task is a word2vec pre-training task. In other embodiments, any suitable self-supervised or unsupervised training task may be used to train the embedding on the clinical text corpus.

The three other training tasks 54, 56, 58 each comprise training the embedding using the data about clinical relatedness 50.

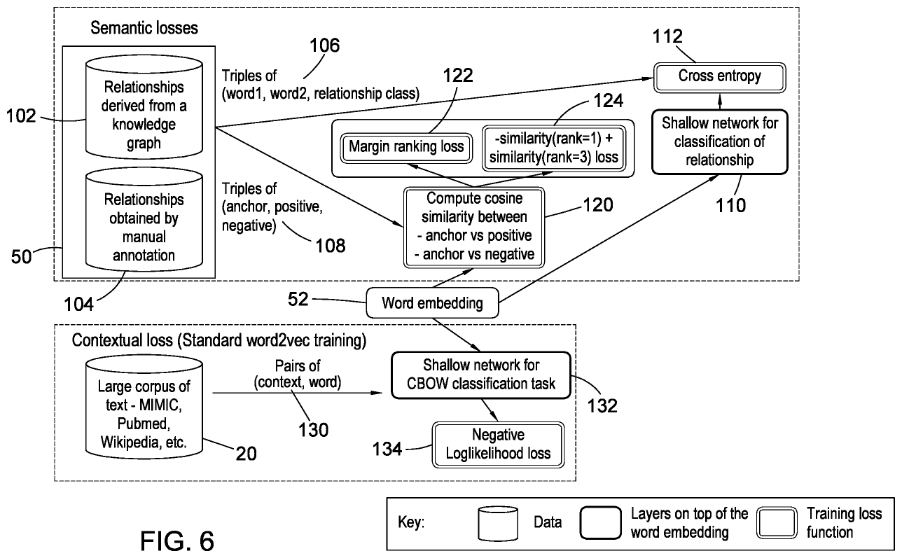

Arrow 55 represents the performing of training task 54 to train the embedding 52. Training task 54 comprises training the embedding using a ranking between triplets of words. Training task 54 is described further below with reference to FIG. 6.

Arrow 57 represents the performing of training task 56 to train the embedding 52. Training task 56 comprises a maximizing or minimizing of cosine similarity. Training task 56 is described further below with reference to FIG. 6.

Arrow 59 represents the performing of training task 58 to train the embedding 52. Training task 58 comprises classifying pairs of words. Training task 56 is described further below with reference to FIG. 6.

Each of the training tasks 54, 56, 58 is a supervised training task using the data about clinical relatedness 50. In some embodiments, the training tasks 54, 56, 58 may require only minimal human supervision.

In other embodiments, the training circuitry 46 may use the data about clinical relatedness 50 to perform any suitable number of other supervised training tasks instead of, or in addition to, training tasks 54, 56 and 58.

In the embodiment of FIG. 4, training tasks 54, 56, 58 are performed concurrently with the standard pre-training task 24. Training tasks 54, 56, 58 are also performed concurrently with each other. Training tasks 54, 56, 58 may be considered to be performed in parallel with the standard pre-training task 24. The embedding 52 is trained using both the text corpus 20 and the data about clinical relatedness 50 at the same time.

Training the embedding 52 using the data about clinical relatedness 50 concurrently with training the embedding 52 using the text corpus 20 may in some circumstances result in a better trained embedding than if the training using the data about clinical relatedness 50 and the training using the text corpus 20 were to be performed sequentially. If the training were sequential, it is possible that learning achieved in a first phase (for example a phase of training using the data about clinical relatedness) may be forgotten during a second phase (for example, a phase of training using the text corpus). The first phase may already puts the model parameters into a local minimum that may prevents the second phase from being effective. Furthermore, only a proportion of words may be present in the data about clinical relatedness, so what happens to the remaining words during training using the data about clinical relatedness may be unpredictable.

In other embodiments, one or more of training tasks 54, 56, 58 may alternate with the standard pre-training task, or with a further one or more of the training tasks 54, 56, 58.

When the training of the embedding 52 is completed, the training circuitry 46 outputs the trained embedding 52. The trained embedding 52 maps each of a plurality of words from the text corpus to a respective vector representation. In other embodiments, any suitable tokens may be mapped to the vector representation. The trained embedding 52 is at the level of tokens or words, not at the level of concepts. Some or all of the plurality of words are medical terms.

In further embodiments, any suitable model may be trained that provides a suitable representation of each of a plurality of tokens.

Vector representations for some of the plurality of words are illustrated in FIG. 4 as dots in a word embedding space 60 which is visualized in 2 dimensions. A proximity of dots in the word embedding space 60 is representative of a degree of similarity as determined by the trained embedding 52.

A solid black dot represents a starting query term. Triangular elements represent terms that have strong relevance to the starting query term, for example terms that are clinical synonyms. Unfilled circular elements represent terms that have weak relevance to the starting query term, for example terms that are clinically associated with the starting query term but are not synonyms of the starting query term. Diamond-shaped elements represent terms that are contextual confounders of the starting query term. Square elements represent terms that are irrelevant to the starting query term.

In the embedding space 60 of FIG. 4, strongly relevant terms surround the starting query. A first circle 64 contains all of the strongly relevant terms, represented by triangular elements. The first circle 64 contains no terms that are not strongly relevant.

Weakly relevant terms are further from the starting query in embedding space 60 than strongly relevant terms. A second circle 62 contains all of the weakly relevant terms, represented by unfilled circular elements, as well as the strongly relevant terms that are inside the first circle 64. Contextual confounders and irrelevant terms are outside the second circle 62.

Training the embedding 22 on both the text corpus 20 and the data about clinical relatedness 50 may allow similarity between terms to be better reflected in the vector representations. By using the data about clinical relatedness 50 in the training of the embedding 52, the embedding 52 may better represent semantic connections between different medical terms. The embedding vectors in the embedding space 60 may be representative of a clinically meaningful relatedness, which reflects clinical knowledge.

The use of different tasks to pre-train an embedding space may make the resulting embedding space particularly suitable for specific natural language processing tasks.

The text processing circuitry 48 is configured to apply the trained embedding 52 in one or more text processing tasks. For example, the one or more text processing tasks may comprise one or more information retrieval tasks. The text processing circuitry 48 may use the trained embedding as an input to a deep learning model, for example a neural network. The text processing circuitry 58 may use the deep learning model to perform any suitable text processing task, for example classification or summarizing.

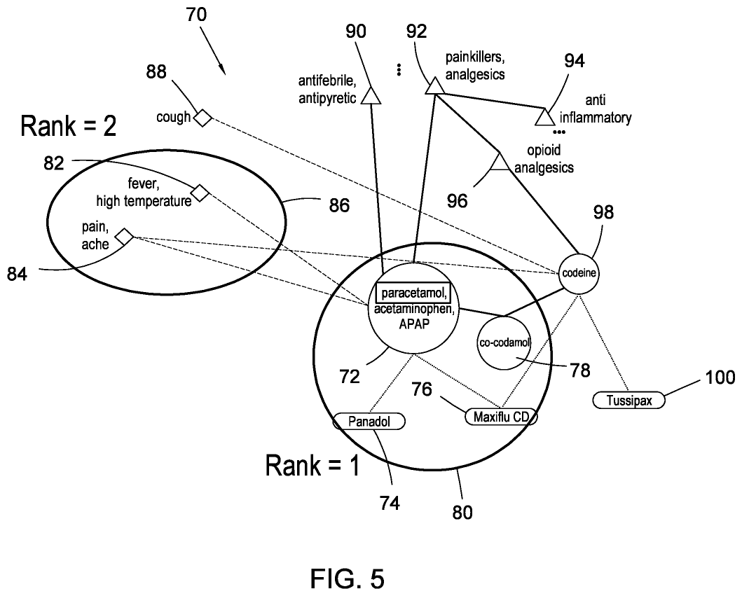

FIG. 5 is a schematic illustration of a first method of obtaining data about clinical relatedness 50. In the method of FIG. 5, relationships are derived from a knowledge graph 70. In other embodiments, any suitable knowledge base may be used. For example, in some embodiments, the semantic circuitry 44 obtains information about clinical relatedness from a knowledge base that does not contain relationships but does contain concepts and their categorization.

One example of a knowledge graph comprising medical information is the Unified Medical Language System (UMLS) knowledge graph. Only a small part of the knowledge graph is shown in FIG. 5. The part of the knowledge graph that is shown in FIG. 5 relates to the term paracetamol. Annotations in FIG. 5 are obtained from the UMLS knowledge graph for the starting query token ‘paracetamol’.

The knowledge graph 70 represents a plurality of concepts. Each concept is a medical concept. Each concept has a respective CUI (Concept Unique Identifier). Concepts are considered to act as nodes of the knowledge graph 70.

Each concept may be associated with one or more medical terms. In FIG. 5, node 72 represents the concept of paracetamol. Node 72 also includes synonyms for paracetamol. In knowledge graph 70, synonyms for paracetamol at node 72 are acetaminophen and apap. Paracetamol, acetaminophen and apap may be referred to as different surface forms of the same concept. If one concept can be expressed in different ways that are completely equivalent, the different words or phrases that are used are called surface forms.

Relationships between the concepts are represented as edges in the knowledge graph 70. An edge is a relationship between two concepts in a knowledge graph. Each edge is labelled with a type of medical relationship. One edge may be labelled as “is a”. As an example, in knowledge graph 70, the relationship “is a” relates node 74 (Penedol), to node 72 (paracetamol, acetaminophen, apap) because Panadol comprises paracetamol. Another edge may be labelled as a close match. Any suitable labeling of edges may be used.

In the method illustrated in FIG. 5, the semantic circuitry 44 obtains semantic relationship information from the knowledge graph 70 using a set of rules. The rules are based on the type of edge and number of edges between a query concept and a candidate match concept. In other embodiments, the rules may be based only the type of edge and not on the number of edges. Edge types may include, for example, “isa”, “inverse_isa”, “has therapeutic class”, “therapeutic class of”, “may treat”, and “may be treated by”. Edges may be navigated to find hyponyms, hypernyms, and/or related concepts.

The query concept may also be referred to as an input query. Candidate matches are possible extensions of the input query to related concepts. Each candidate match is ranked using the set of rules. Some candidate matches may be exact matches to the query concept. Other candidate matches may be related terms. Further candidate matches may be unrelated terms.

In FIG. 5, the query concept is paracetamol.

A first rank, rank=1, is applied to all alternative surface forms and all concepts within two edges which follow a small selection of edge classes (for example, inverse_isa).

In FIG. 5, circle 80 contains nodes 72, 74, 76 and 78. Circle 80 represents a region of the knowledge graph in which the nodes are designated as rank=1. Node 72 contains the starting query token paracetamol and its alternative surface forms acetaminophen and apap. Node 74 contains the term Panadol. Node 76 contains the term Maxiflu CD. Node 76 contains the term co-codamol. Any medical terms included in concepts having rank=1 may be considered to be of strong relevance to the starting query token.

A second rank, rank=2 is applied to any concept that is within one edge of the starting query term, but is not in the rank=1 group. In FIG. 5, circle 86 contains nodes 82 and 84. Circle 90 represents a region of the knowledge graph in which the nodes are designated as rank=2. Node 82 includes the medical terms fever and high temperature. Node 84 includes the medical terms pain and ache. Any medical terms included in concepts having rank=2 may be considered to be weakly relevant to the starting query token.

The knowledge graph 70 shown in FIG. 5 also contains further nodes 88, 90, 92, 94, 96, 98, 100. Further nodes 88, 90, 92, 94, 96, 98, 100 comprise a random selection of tokens that are not in the nearest neighbors of a previous embedding space and are not in rank=1 and rank=2 groups. The previous embedding space may be an embedding space that is trained using a standard contextual loss. The previous embedding space may be used to select candidate pairs to train with augmented losses, for example losses as described below with reference to FIG. 6.

Each of further nodes 88, 90, 92, 94, 96, 98, 100 is given a rank=negative/false. In FIG. 5, further node 88 contains cough, further node 90 contains anti-febrile and antipyretic, further node 92 contains painkillers and analgesics, further node 94 contains anti-inflammatory, further node 96 contains opioid analgesics, further node 98 contains codeine and further node 100 contains Tussipax.

The semantic circuitry 44 is configured to automatically extract the semantic relationship information from the knowledge graph 70. The semantic circuitry 44 is provided with the set of rules. The set of rules may be stored in data store 14 or in any suitable data store. Semantic circuitry 44 then applies the set of rules to the knowledge graph to obtain rank values for each of the nodes in the knowledge graph with reference to each starting query token. The semantic circuitry 44 applies the rules by following the edges of the knowledge graph. For example, the semantic circuitry 44 may be told to follow an edge that says “is a” or is a close match.

In the example shown in FIG. 5, the rankings applied are rank=1, rank=2 and rank=negative/false. In other embodiments, any suitable rankings may be used and any number of rankings may be used. A minimum ranking may be to rank nodes as relevant or irrelevant. In other embodiments, nodes may be ranked as highly relevant, relevant, weakly relevant or irrelevant.

The ranking numbers may be described as semantic ranking values or semantic relationship values, where each pair of medical terms has a semantic ranking value describing a degree of semantic similarity between the medical terms. For example, in the case of paracetamol and Penedol the semantic ranking value is 1. For paracetamol and pain, the semantic ranking value is 2. In some embodiments, a numerical value is also assigned to the rank of negative/false.

In FIG. 5, the semantic circuitry 44 derives semantic ranking values from a knowledge graph 70. In other embodiments, the semantic circuitry 44 may alternatively or additionally obtain semantic ranking values from a set of manual annotations provided by one or more experts, for example one or more clinicians. An expert may perform an annotation of relationships between queries and findings in a set of training data. A set of clinical rules may inform the way the annotations are performed by the expert. The rules may form a clinical annotation protocol. In some embodiments, the clinical annotation protocol is developed by the annotating expert. In other embodiments, the clinical annotation protocol may be developed by another person or entity. The use of a clinical annotation protocol may ensure consistency in ranking, particularly in cases where more than one expert is performing annotation.

In some cases, a relationship between a pair of medical terms (query, finding) may be a linguistic relationship. For example, the linguistic relationship may be that of a synonym, an association or a misspelling.

In other cases, a relationship between a pair of medical terms (query, finding) may be a semantic relationship. For example, the semantic relationship may be a relationship from an anatomy to a symptom or from a medicine to a disease.

In further cases, a relationship between a pair of medical terms (query, finding) may indicate a clinical relevance of the finding to the query.

For instance, for the query paracetamol, it is possible to annotate its relationship to candidate match terms as shown in Table 1 below. Each of the candidate match terms is ranked as rank 1, rank 2, rank 3 or false result. Ranking may be in dependence of any one or more of linguistic relationship, semantic relationship and clinical relevance as obtained by manual annotation. Semantic ranking values between pairs of words may comprise ranks, for example as numerical values.

| | Candidate | | | Clinical | |
|---|---|---|---|---|---|
| Input query | match | Linguistic | Semantic | relevance | Rank |
| Paracetamol | paractmol | Misspelling | Same type | Highly | 1 |
| | | | | relevant | |
| Paracetamol | Analgesic | Hypernym | Same type | Relevant | 2 |
| Paracetamol | Headache | Association | Medication-> | Weakly | 3 |
| | | | Symptom | relevant | |
| Paracetamol | Salbutamol | Irrelevant | Same type | Irrelevant | False |
| | | | | | result |

Clinical relevance may be considered to be driving factor in ranking. Rules may also be based on linguistic and semantic criteria, for example different forms of the word (linguistically related, semantically the same) are ranked highest, followed by synonyms (linguistic relationship unimportant, semantically same meaning), followed by clinically associated words where semantic rules are created by selecting the relationships that are most clinically useful. More distantly related words may also be given a ranking. For example, paracetamol and morphine may be considered to be sibling concepts.

In further embodiments, any suitable method may be used to obtain data about clinical relatedness, for example to obtain a set of semantic ranking values for pairs of medical terms.

In further embodiments, the semantic circuitry 44 receives a set of user inputs and annotates a set of clinical data based on the user inputs. The user inputs may be obtained from the interaction of one or more users with the apparatus 30 or with a further apparatus. For example, the one or more users may provide labels for medical terms. The one or more users may correct system outputs, for example by correcting a mis-identified synonym. The one or more users may indicate a relationship between a pair of medical terms. The training circuitry 46 may collect and process the user inputs, for example the labels, corrections or indications of relationships. The training circuitry 46 may use the user inputs to annotate the clinical data. In some embodiments, the one or more users are not asked directly to provide an annotation. Instead, the user's inputs are obtained as part of routine interactions between the one or more users and the apparatus.

In other embodiments, any suitable method may be used to obtain one or more sources of semantic relationship supervision for training a word embedding. Semantic information may be obtained by any suitable method, which may be manual or automated.

Embodiments described above make use of a plurality of different ranking values to reflect a plurality of degrees of semantic similarity. For example, synonyms are distinguished from words that are less strongly related. Strongly related words may be distinguished from words that are more weakly related. By using multiple degrees of semantic similarity in training, it may be the case that better representations are obtained than would be obtained using only a difference between synonyms and non-synonyms.

FIG. 6 is a flow chart illustrating the same method of training a word embedding 52 as in FIG. 4. FIG. 6 includes examples of proposed losses using supervision sources as described above with reference to FIG. 5 and Table 1.

In FIG. 6, the data about clinical relatedness 50 comprises two supervision sources. A first supervision source 102 comprises a set of relationships derived from a knowledge graph. A second supervision source 104 comprises a set of relationships obtained by manual annotation. Each set of relationships 102, 104 comprises a respective set of semantic ranking values that is obtained. Each of the semantic ranking values is representative of a degree of semantic similarity between a respective pair of medical terms. In other embodiments, any suitable number or type of supervision sources may be used, where each supervision source comprises semantic information.

The training circuitry 46 obtains from the first and/or second supervision source 102, 104 a first set of triples 106. Each triple in the first set of triples 106 comprises a respective pair of medical terms and a relationship class that indicates a relationship between the medical terms. Each triple may be written as (word1, word2, relationship class) where word1 and word2 are the medical terms that are related by the relationship class.

A layer 110 on top of the word embedding 52 comprises a shallow network for classification of relationship. The training circuitry 46 uses a training loss function comprising a cross entropy 112 to train the network to perform a classification of relationship class using the first set of triples 106. The training circuitry 46 trains the embedding to provide improved classification. In other embodiments, any suitable loss function may be used.

The training using the first set of triples 106 is shown in FIG. 4 as training task 58, classifying pairs of words.

The training circuitry 46 obtains from the first and/or second supervision source 102, 104 a second set of triples 108. Each triple in the second set of triples 108 comprises an anchor term, a positive term, and a negative term. Each of the anchor term, positive term and negative term may comprise a word or another token. The triple may be written as (anchor, positive, negative). The positive term is an example of a term that is ranked highly with reference to the anchor term. For example, a relationship between the anchor and the positive term may be of rank 1. The negative term is an example of a term that is ranked lower than the positive term with reference to the anchor term. For an example, a relationship between the anchor and the negative term may be of rank 3.

The training circuitry 46 is configured to perform a task 120 in which a cosine similarity is computed between anchor versus positive, and between anchor versus negative in each of the triples of the second set of triples 108. In the embodiment of FIG. 6, two different loss functions 122, 124 are used with regard to the cosine similarity of task 120. A first loss function 122 is a margin ranking loss. A second loss function 124 may be written as −similarity (rank=1 or 2)+similarity (rank=4) loss.

Cosine similarity may be used as an alternative to triplet loss (which uses only relative rankings), and enforce that pairs that are ranked highly are close according to cosine similarity (absolute distance), and that pairs with lower ranking (not related) are far according to cosine similarity.

In the embodiment of FIG. 6, the loss functions 122, 124 take the same inputs, but the first loss function 122 enforces a correct relative ranking of differently categorized words, and the second loss function 124 enforces good absolute spacing.

In other embodiments, any suitable loss function or functions may be used.

The training circuitry 46 uses the training loss functions 122, 124 to train the embedding to minimize a difference between the positive term and the anchor term, and to maximize a difference between the negative term and the anchor term.

The training using the second set of triples 108 is shown in FIG. 4 as training task 54, ranking between triplets of words, and training task 56, maximizing/minimizing cosine similarity.

The training tasks 54, 56, 58 that are based on data about clinical relatedness 50 are performed using semantic losses.

Standard word2vec training task 24 is also performed. The word2vec training task uses contextual loss.

A large corpus of text 20 may be obtained from any suitable source, for example MIMIC (MIMIC-III, a freely accessible critical care database. Johnson A E W, Pollard T J, Shen L, Lehman L, Feng M, Ghassemi M, Moody B, Szolovits P, Celi L A, and Mark R G. Scientific Data (2016). DOI: 10.1038/sdata.2016.35), Pubmed or Wikipedia.

The training circuitry 46 obtains from their corpus of text 20 a set of pairs 130. Each pair (context, word) comprises a context and a word. In other embodiments, any token may be used in place of the word. The context may comprise a section of text of any suitable length.

A layer 132 on top of the word embedding 52 comprises a shallow network for a continuous bag of words (see CBOW) classification task. The training circuitry 46 uses a training loss function comprising a negative log likelihood loss 134 to train the shallow network to perform the CBOW classification task using the set of pairs 130. The training circuitry 46 trains the embedding to provide improved CBOW classification. In other embodiments, any suitable loss function may be used.

In the embodiment of FIG. 6, the word embedding is trained on up to four tasks concurrently. Pairs of triples are sampled at an empirically determined ratio for each of the constituent losses. Only one of the tasks is based on the corpus 20. The other tasks use semantic information that is separate from the corpus 20.

In other embodiments, any suitable number of training tasks may be used. One or more of the training tasks may comprise self-supervised or unsupervised learning using a text corpus 20. A further one or more of the training tasks may comprise supervised learning using semantic relationship information that does not form part of the text corpus 20.

After the training, the nearest neighbor search in the resulting embedding space may better reflect requirements of a word-level information retrieval task.

The losses used in the embodiment of FIG. 6 are based on clinical relationship. In other embodiments, linguistic losses may also be used.

In further embodiments, the training circuitry 46 may use pseudo-supervision using fuzzy matching/grouping of misspellings and abbreviations within the original word embedding.

In some embodiments, the text processing circuitry 48 uses the embedding that is trained using the method of FIG. 4 and FIG. 6 for information retrieval and search. Nearest neighbors in the embedding space may be used for query expansion. In some embodiments, context information may also be used.

In some embodiments, the text processing circuitry 48 uses the trained embedding for information extraction, for example for Named Entity Recognition (NER). In some embodiments, a deep learning NER algorithm may be used.

In other embodiments, the text processing circuitry 48 may use the trained embedding in any other clinical application using deep learning. Word embedding pre-training may be especially important when limited training data is available.

The trained embedding may be used in classification, for example radiology reports classification. The trained embedding may be used in summarization, for example automated report summarization.

A search method using an embedding trained using the method of FIG. 4 was evaluated. It was found that an embedding trained using the method of FIG. 4 provided increased accuracy and precision for synonyms and for associations when compared with a standard embedding.

In further embodiments, the method as described above with reference to FIG. 4 and FIG. 6 may be extended to Transformer architectures. Transformer architectures are used for many natural language processing tasks. One example of a transformer model is BERT.

In some embodiments, standard pre-training tasks may be combined with one or more of the training tasks 54, 56, 58 described above with reference to FIG. 4 and FIG. 6. For example, the standard pre-training tasks may comprise masked language prediction or next sentence classification.

BERT produces contextual embeddings. A word's representation depends on its host sentence. Training tasks may be adapted to contextual embeddings in different ways in different embodiments.

In some embodiments, tasks are learned naïvely for the constituent words in a training sentence.

In other embodiments, pre-processing steps may be added to infer more appropriate context-sensitive supervision. The context-sensitive supervision may comprise a context-sensitive ranking, similarity or classification.

For example, one type of context-sensitive supervision may comprise differentiating between homonyms, where homonyms are words that are spelled the same but have 2 different meanings. An example of a homonym in a medical context is ASD, which refers to both Autistic Spectrum Disorder and Atrial Septal Defect. In some embodiments, word context is used to match words to their correct counterpart in a knowledge base, for example a knowledge graph. A semantic context, for example comprising graph edges and semantic type, may be matched to a sentence context.

A further type of context-sensitive supervision may comprise differentiating words that have slightly different meanings depending on the context. For example, stroke may refer to a neurological stroke or a heat stroke. In the case of a neurological stroke, CVA would be a synonym for stroke. In the case of a heat stroke, CVA would not be a synonym.

In general, contextualized embeddings such as BERT cannot be used for query expansion in the same way as context-free embeddings. However, contextualized embeddings may be used to support information retrieval through indexing of documents. Contextualized embeddings may be used to support information retrieval by filtering findings using context in the text being searched. Contextualized embeddings may be used to support information retrieval through interpretation of longer user queries. Query expansions may be generated dependent on the context of the term in the query. For example, an embedding of a query may be compared to an embedding of a sentence.

In the embodiments described above, an embedding is trained for terms that are in the clinical/medical domain. In further embodiments, methods as described above may be used to train an embedding to perform natural language processing tasks on free text in any domain having ontological relationships, for example in biology, chemistry or drug discovery. Training of the embedding may be automatic. Training of the embedding may be rule driven, for example by use of a knowledge graph. Training of the embedding may rely on data provided by an expert.

Whilst particular circuitries have been described herein, in alternative embodiments functionality of one or more of these circuitries can be provided by a single processing resource or other component, or functionality provided by a single circuitry can be provided by two or more processing resources or other components in combination. Reference to a single circuitry encompasses multiple components providing the functionality of that circuitry, whether or not such components are remote from one another, and reference to multiple circuitries encompasses a single component providing the functionality of those circuitries.

Whilst certain embodiments have been described, these embodiments have been presented by way of example only, and are not intended to limit the scope of the invention. Indeed the novel methods and systems described herein may be embodied in a variety of other forms. Furthermore, various omissions, substitutions and changes in the form of the methods and systems described herein may be made without departing from the spirit of the invention. The accompanying claims and their equivalents are intended to cover such forms and modifications as would fall within the scope of the invention.

1. A medical information processing apparatus comprising:
a memory which stores a plurality of semantic ranking values for a plurality of medical terms, wherein each of the semantic ranking values relates to a degree of semantic similarity between a respective pair of the medical terms; and
processing circuitry configured to train a model based on the semantic ranking values, wherein the model comprises a respective vector representation for each of the medical terms.

2. An apparatus according to claim 1, wherein the training of the model comprises at least one training task in which the model is trained on the semantic ranking values, and a further, different training task in which the model is trained using word context in a text corpus.

3. An apparatus according to claim 2, wherein the training of the model comprises performing at least part of the further, different training task concurrently with at least part of the at least one training task.

4. An apparatus according to claim 1, wherein at least some of the semantic ranking values are determined based on a knowledge base.

5. An apparatus according to claim 4, wherein the knowledge base comprises a knowledge graph that represents relationships between the plurality of medical terms as edges in the knowledge graph.

6. An apparatus according to claim 5, wherein the processing circuitry is further configured to perform the determining of the semantic ranking values based on the knowledge graph, wherein the determining comprises, for each pair of medical terms, applying at least one rule based on types of edge and number of edges between the pair of medical terms to obtain the semantic ranking value for said pair of medical terms.

7. An apparatus according to claim 1, wherein at least some of the semantic ranking values are obtained by expert annotation of pairs of the medical terms according to an annotation protocol.

8. An apparatus according to claim 1, wherein the processing circuitry is further configured to receive user input and to process the user input to obtain at least some of the semantic ranking values.

9. An apparatus according to claim 1, wherein the semantic ranking value for each pair of medical terms comprises numerical information that is indicative of the degree of semantic similarity between the pair of medical terms.

10. An apparatus according to claim 1, wherein the training of the model comprises using a loss function that is based on the semantic ranking values.

11. An apparatus according to claim 2, wherein the at least one training task comprises ranking words according to a degree of relatedness to a reference word.

12. An apparatus according to claim 2, wherein the at least one training task comprises predicting a class of a relationship between two words.

13. An apparatus according to claim 2, wherein the at least one training task comprises maximizing or minimizing a cosine similarity between vector representations.

14. An apparatus according to claim 1, wherein the vector representation for each of the medical terms is dependent on the context of said medical term within a text.

15. An apparatus according to claim 1, wherein the processing circuitry is further configured to use the vector representations to perform an information retrieval task.

16. An apparatus according to claim 15, wherein the information retrieval task comprises at least one of: finding an alternative word for a user query, indexing a document, evaluating a relationship between a user query and one or more words within a document.

17. An apparatus according to claim 1, wherein the processing circuitry is further configured to:
receive input text data;
pre-process the input text data using the model to obtain a vector representation of the input text data; and
use a further model to process the vector representation of the input text data to obtain a desired output.

18. An apparatus according to claim 17, wherein the desired output comprises at least one of: a labeling of the input text data, extraction of information from the input text data, a classification of the input text data, a summarization of the input text data.

19. A method comprising:
obtaining a plurality of semantic ranking values for a plurality of medical terms, wherein each of the semantic ranking values relates to a degree of semantic similarity between a respective pair of the medical terms; and
training a model based on the semantic ranking values, wherein the model comprises a respective vector representation for each of the medical terms.

20. A medical information processing apparatus comprising processing circuitry configured to:
apply a model to input text data to obtain a vector representation of the input text data, wherein the model is trained based on a plurality of semantic ranking values for a plurality of medical terms, each of the semantic ranking values relating to a degree of semantic similarity between a respective pair of the medical terms; and
use the vector representation of the input text data to perform an information retrieval task, or use a further model to process the vector representation of the input text data to obtain a desired output.

21. A method comprising:
applying a model to input text data to obtain a vector representation of the input text data, wherein the model is trained based on a plurality of semantic ranking values for a plurality of medical terms, each of the semantic ranking values relating to a degree of semantic similarity between a respective pair of the medical terms; and
using the vector representation of the input text data to perform an information retrieval task, or using a further model to process the vector representation of the input text data to obtain a desired output.
